(19) United States
(12) Patent Application Publication
(10) Pub. No.: US 2025/0192381 A1
(43) Pub. Date: Jun. 12, 2025

(54) BATTERY PACK ELECTRICAL CONNECTION SYSTEM

(71) Applicant: Ford Global Technologies, LLC, Dearborn, MI (US)

(72) Inventors: Douglas Christian Lipp, Ann Arbor, MI (US); Deanna Marie Winton Hoffman, Ann Arbor, MI (US); Alex Revels, Canton, MI (US); Ryan Douglas Matulich, Farmington, MI (US); Antony George Schepak, Howell, MI (US)

(21) Appl. No.: 18/637,762

(22) Filed: Apr. 17, 2024

Related U.S. Application Data
(60) Provisional application No. 63/607,888, filed on Dec. 8, 2023.

(51) Int. Cl. H01M 50/517

(52) U.S. Cl. CPC H01M 50/517

(57) ABSTRACT

A battery pack electrical connection system includes a first electrical contact associated with a first cell stack, and a second electrical contact associated a second cell stack. The first electrical contact is connected to the second electrical contact. The first electrical contact is tilted further away from the second electrical contact prior to being connected to the second electrical contact than after being connected to the second electrical contact.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs and, more particularly, to electrically connecting cell stacks of traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a battery pack electrical connection system, including: a first electrical contact associated with a first cell stack; and a second electrical contact associated a second cell stack, the first electrical contact connected to the second electrical contact, the first electrical contact tilted further away from the second electrical contact prior to being connected to the second electrical contact than after being connected to the second electrical contact.

In some aspects, the techniques described herein relate to a battery pack electrical connection system, further including a fastener that extends through a first aperture in the first electrical contact and a second aperture in the second electrical contact, the fastener connecting the first electrical contact to the second electrical contact.

In some aspects, the techniques described herein relate to a battery pack electrical connection system, wherein the fastener is a threaded fastener.

In some aspects, the techniques described herein relate to a battery pack electrical connection system, wherein the first aperture of the first electrical contact is vertically above the second aperture of the second electrical contact when the first electrical contact is connected to the second electrical contact.

In some aspects, the techniques described herein relate to a battery pack electrical connection system, wherein a portion of the first electrical contact having the first aperture projects laterally away from the first cell stack, wherein a portion of the second electrical contact having the second aperture projects laterally away from the second cell stack.

In some aspects, the techniques described herein relate to a battery pack electrical connection system, wherein the first electrical contact is tilted upward further away from the second electrical contact prior to being connected to the second electrical contact than after being connected to the second electrical contact.

In some aspects, the techniques described herein relate to a battery pack electrical connection system, further including at least one terminal of a battery cell of the first cell stack that is connected directly to the first electrical contact, and at least one terminal of a battery cell of the second cell stack that is connected directly to the second electrical contact.

In some aspects, the techniques described herein relate to a battery pack electrical connection system, wherein the at least one terminal of the battery cell of the first cell stack is a tab terminal, wherein the at least one terminal of the battery cell of the second cell stack is a tab terminal.

In some aspects, the techniques described herein relate to a battery pack electrical connection system, including: a more flexible contact and a less flexible contact that project from a first cell stack; and a more flexible contact and a less flexible contact that project from a second cell stack, the more flexible contact of the first cell stack connected directly to the less flexible contact of the second cell stack, the more flexible contact of the second cell stack connected directly to the less flexible contact of the first cell stack.

In some aspects, the techniques described herein relate to a battery pack electrical connection system, wherein the more flexible contact that projects from the first cell stack is tilted further away from the less flexible contact of the second cell stack prior to being connected to the less flexible contact of the second cell stack, wherein the more flexible contact that projects from the second cell stack is tilted further away from the less flexible contact of the first cell stack prior to being connected to the less flexible contact of the first cell stack.

In some aspects, the techniques described herein relate to a battery pack electrical connection system, wherein at least one terminal of a battery cell of the first cell stack is connected directly to the more flexible contact that projects from the first cell stack, and at least one terminal of a battery cell of the first cell stack is connected directly to the less flexible contact that projects from the first cell stack.

In some aspects, the techniques described herein relate to a battery pack electrical connection method, including: overlapping a first electrical contact that projects from a first cell stack with a second electrical contact that projects from a second cell stack; connecting the first electrical contact and the second electrical contact; and tilting the first electrical contact toward the second electrical contact during the connecting.

In some aspects, the techniques described herein relate to a battery pack electrical connection method, further including connecting the first electrical contact to the second electrical contact with a mechanical fastener.

In some aspects, the techniques described herein relate to a battery pack electrical connection method, wherein the tilting includes tilting the first electrical contact vertically downward.

In some aspects, the techniques described herein relate to a battery pack electrical connection method, wherein the first electrical contact is flexible relative to the second electrical contact.

In some aspects, the techniques described herein relate to a battery pack electrical connection method, wherein the first electrical contact is a first busbar connected directly to a first terminal of a first battery cell, and the second electrical contact is a second busbar connected directly to a second terminal of a second battery cell.

In some aspects, the techniques described herein relate to a battery pack electrical connection method, wherein the first battery cell is within the first cell stack, and the second battery cell is within a second cell stack.

In some aspects, the techniques described herein relate to a battery pack electrical connection method, wherein the first electrical contact and the second electrical contact are more aligned after the connecting than before the connecting.

In some aspects, the techniques described herein relate to a battery pack electrical connection method, further including moving the first cell stack and the second cell stack closer to each other to cause the overlapping.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a perspective view of a battery cell the battery pack of FIG. 2.

FIG. 4 illustrates a side view of two cell stacks from the battery pack of FIG. 2 moving to the installed position.

FIG. 5 illustrates a top perspective view of portions of the two cell stacks in the position of FIG. 4.

FIG. 6 illustrates a side view of the two cell stacks of FIG. 4 in the installed position.

FIG. 7 illustrates a top perspective view of portions of the two cell stacks in the position of FIG. 6.

### DETAILED DESCRIPTION

This disclosure details electrical connection systems for use in traction battery packs particularly connection systems that can be used in area with packaging constraints.

The connection systems can include a terminal associated with a first cell stack connected to a terminal associated with a second cell stack. Prior to connecting the terminals, at least one of the terminals can be tilted. The tilting can, among other things, facilitate moving the terminals into a position where they can be connected. These and other features are discussed in greater detail in the following paragraphs of this detailed description.

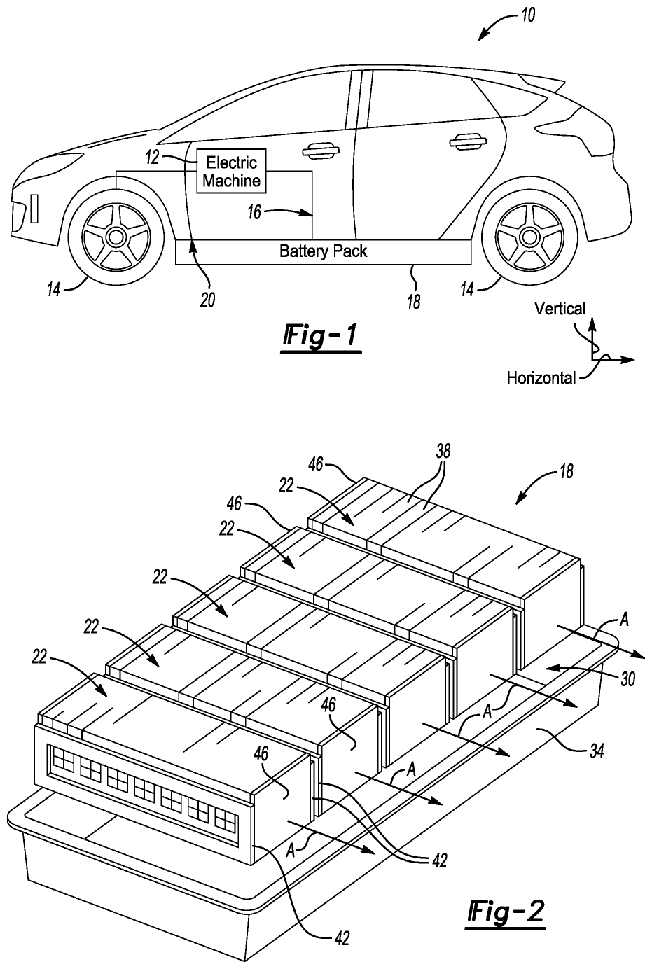

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

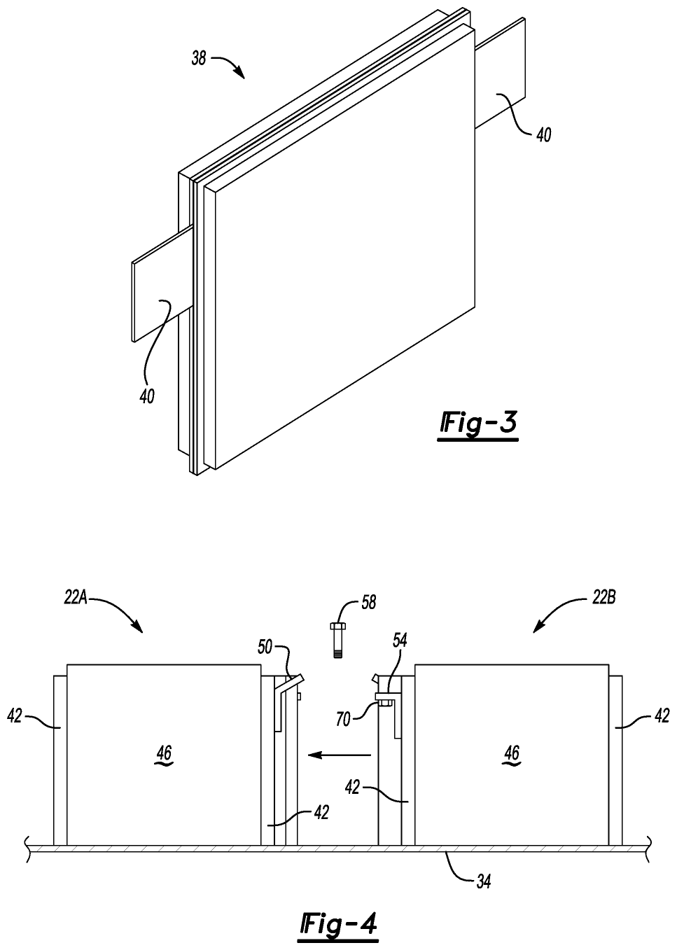

With reference to FIGS. 2 and 3, the traction battery pack 18 may include a plurality of cell stacks 22 housed within an interior area 30 of an enclosure—here an enclosure tray 34. The enclosure tray 34 can be secured to an enclosure cover, the underbody 20, or both to enclose the cell stacks 22 and other battery internal components within the interior area 30.

Each cell stack 22 includes a plurality of battery cells 38 stacked side-by-side relative to one another along a respective cell stack axis A. The battery cells 38 store and supply electrical power for powering various components of the electrified vehicle 10. Although a specific number of the cell stacks 22 and battery cells 38 are illustrated in the various figures of this disclosure, the traction battery pack 18 could include any number of the cell stacks 22, with each cell stack 22 having any number of individual battery cells 38.

in the exemplary embodiment, the battery cells 38 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 38 include tab terminals 40 that project outwardly from a battery cell housing. At least some of the tab terminals 40 of each cell stack 22 are electrically connected to busbars, for example, in order to provide the voltage and power levels necessary for achieving vehicle propulsion.

One or more dividers may be arranged along the respective cell stack axis A of each cell stack 22. The dividers may compartmentalize each cell stack 22 into two or more groupings or compartments of battery cells 38. Each compartment may hold one or more of the battery cells 38 of the cell stack 22.

The battery cells 38 of each cell stack 22 are arranged between a pair of cross-member assemblies 42. Among other functions, the cross-member assemblies 42 may be configured to hold the battery cells 38 and at least partially delineate the cell stacks 22 from one another within the interior area 30.

Each cross-member assembly 42 may be configured to transfer a load applied to a side of the electrified vehicle 10, for example, for ensuring that the battery cells 38 do not become overcompressed. Each cross-member assembly 42 may be further configured to accommodate tension loads resulting from expansion and retraction of the battery cells 38. The cross-member assemblies 42 described herein are configured to increase the structural integrity of the traction battery pack 18.

In an embodiment, the cell stacks 22 and the cross-member assemblies 42 extend longitudinally in a cross-vehicle direction of the electrified vehicle 10. However, other configurations are contemplated within the scope of this disclosure.

The cell stacks 22 may be arranged to extend along their respective cell stack axes A between opposing end plates 46. One or more end plates 46 may be positioned between each end of each cell stack 22 and a side wall of the enclosure tray 34.

With reference now to FIGS. 4-7 and continuing reference to FIG. 2, the cell stacks 22 in installed positions are electrically connected together within the traction battery pack 18. Electrical contacts are used to electrically connect together the cell stacks 22.

In this example, a first electrical contact 50 associated with the cell stack 22A is connected to a second electrical contact 54 that is associated with the cell stack 22B to electrically connect the cell stack 22A to the cell stack 22B. A mechanical fastener 58 is used to connect the first electrical contact 50 to the second electrical contact 54. In another example, welds could be used to connect the first electrical contact 50 to the second electrical contact 54. In still another example, clinching could be used as a connecting method.

The mechanical fastener 58 extends through an aperture 62 in the first electrical contact 50 and an aperture 66 in the second electrical contact 54 when connecting the first electrical contact 50 to the second electrical contact 54. The mechanical fastener 58, in this example, is a threaded fastener that threadably engages a weld nut 70 when connecting the first electrical contact 50 to the second electrical contact 54. The aperture 62 can be oversized relative to the aperture 66 to facilitate aligning the mechanical fastener 58.

A platform portion 74 of the first electrical contact 50 projects laterally away from the cell stack 22A. The aperture 62 is provided within the platform portion 74. Correspondingly, a platform portion 78 of the second electrical contact 54 projects laterally away from the cell stack 22B. The aperture 66 is provided within the platform portion 78. The platform portion 74 extends at an upward angle from the cell stack 22A whereas the platform portion 78 extends substantially horizontally from the cell stack 22B.

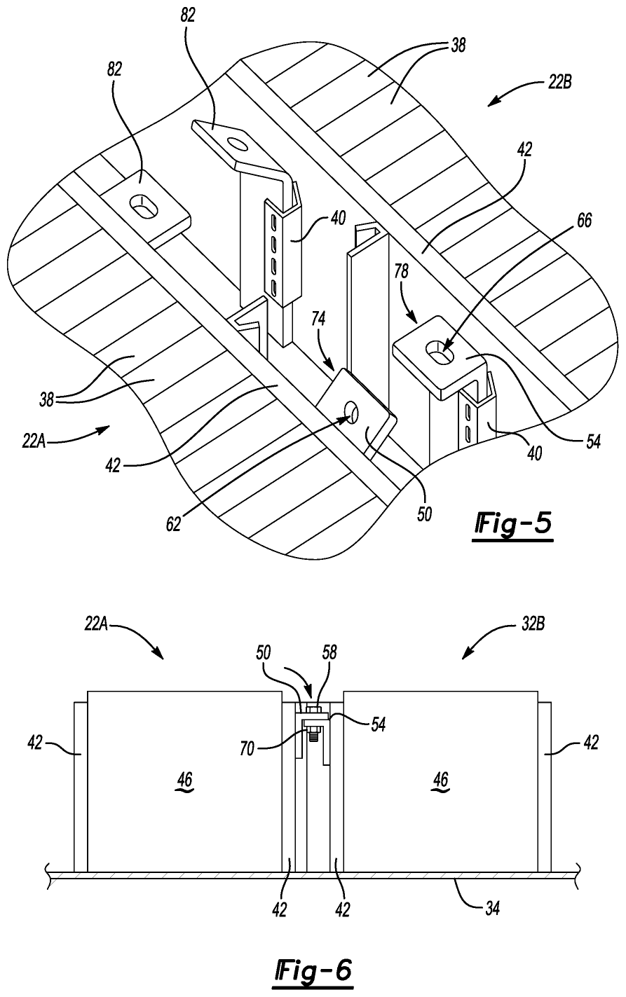

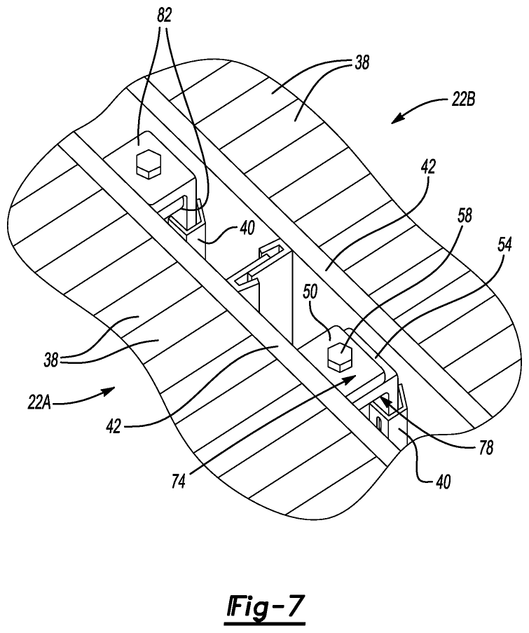

As shown in FIGS. 4 and 5, the first electrical contact 50 is thus tilted away from the second electrical contact 54 prior to the first electrical contact 50 connecting to the second electrical contact 54. More specifically, in this example, the platform portion 74 is tilted away from the platform portion 78 prior to connecting the first electrical contact 50 to the second electrical contact 54. The tilt, which can be a slight upward tilt, allows the first electrical contact 50 to, in this example, slide from the positions of FIGS. 4 and 5 to the positions of FIGS. 6 and 7 with little interference.

After the platform portion 74 is moved into a position overlapping the platform portion 78, the fastener 58 is inserted in the aperture 62 and the aperture 66. The fastener 58 is torqued to connecting the first electrical contact 50 to the second electrical contact 54, which flexes the first electrical contact 50 toward the second electrical contact 54 tilting the platform portion 74 vertically downward. The first electrical contact 50 is thus tilted further from the second electrical contact 54 prior to being connected to the second electrical contact 54 than after being connected to the second electrical contact 54.

The aperture 62 of the first electrical contact 50 is vertically above the aperture 66 of the second electrical contact 54 when the first electrical contact 50 is connected to the second electrical contact 54. The tilting of the first electrical contact 50 can facilitate positioning the aperture 66 of the second electrical contact 54 beneath the aperture 62 of the first electrical contact 50 as the cell stack 22A and the first electrical contact 50 are moved horizontally closer to the second electrical contact 54 and the cell stack 22B to align the aperture 62 with the aperture 66. The tilting can help the first electrical contact 50 slide unobstructed over the second electrical contact 54.

Vertical and horizontal, for purposes of this disclosure, are with reference to ground and a general orientation of traction battery pack 18 when installed within the electrified vehicle 10 of FIG. 1.

Since the connecting the first electrical contact 50 to the second electrical contact 54 flexes the first electrical contact 50 toward the second electrical contact 54, the first electrical contact 50 is considered a more flexible contact and the second electrical contact 54 is considered a less flexible contact.

At least one of the tab terminal 40 within the cell stack 22A can be connected directly to the first electrical contact 50. At least one tab terminal 40 within the cell stack 22B can be connected directly to the second electrical contact 54. Spot welds can be used to connect the tab terminals 40 to the first electrical contact 50 or the second electrical contact 54. An electric current can thus flow from a tab terminal 40 of the cell stack 22A through the first electrical contact 50 directly to the second electrical contact 54 without an intervening structure. The first electrical contact 50 and the second electrical contact 54 can effectively provide a combined busbar and terminal interconnect for a cell stack.

As shown in FIGS. 5 and 7, other electrical contacts 82 can electrically connect the cell stack 22A to the cell stack 22B. The tilting relationship of these electrical contacts 82 can differ from the first electrical contact 50 and the second electrical contact 54. In this example, one of the electrical contacts 82 protruding from the cell stack 22B is more tilted than the electrical contact 82 protruding from the cell stack 22A prior to connecting the electrical contacts 82. This is an opposite arrangement from the first electrical contact 50 and the second electrical contact 54.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack electrical connection system, comprising:
a first electrical contact associated with a first cell stack; and
a second electrical contact associated a second cell stack, the first electrical contact connected to the second electrical contact, the first electrical contact tilted further away from the second electrical contact prior to being connected to the second electrical contact than after being connected to the second electrical contact.

2. The battery pack electrical connection system of claim 1, further comprising a fastener that extends through a first aperture in the first electrical contact and a second aperture in the second electrical contact, the fastener connecting the first electrical contact to the second electrical contact.

3. The battery pack electrical connection system of claim 2, wherein the fastener is a threaded fastener.

4. The battery pack electrical connection system of claim 2, wherein the first aperture of the first electrical contact is vertically above the second aperture of the second electrical contact when the first electrical contact is connected to the second electrical contact.

5. The battery pack electrical connection system of claim 4, wherein a portion of the first electrical contact having the first aperture projects laterally away from the first cell stack, wherein a portion of the second electrical contact having the second aperture projects laterally away from the second cell stack.

6. The battery pack electrical connection system of claim 1, wherein the first electrical contact is tilted upward further away from the second electrical contact prior to being connected to the second electrical contact than after being connected to the second electrical contact.

7. The battery pack electrical connection system of claim 1, further comprising at least one terminal of a battery cell of the first cell stack that is connected directly to the first electrical contact, and at least one terminal of a battery cell of the second cell stack that is connected directly to the second electrical contact.

8. The battery pack electrical connection system of claim 7, wherein the at least one terminal of the battery cell of the first cell stack is a tab terminal, wherein the at least one terminal of the battery cell of the second cell stack is a tab terminal.

9. A battery pack electrical connection system, comprising:
a more flexible contact and a less flexible contact that project from a first cell stack; and
a more flexible contact and a less flexible contact that project from a second cell stack, the more flexible contact of the first cell stack connected directly to the less flexible contact of the second cell stack, the more flexible contact of the second cell stack connected directly to the less flexible contact of the first cell stack.

10. The battery pack electrical connection system of claim 9, wherein the more flexible contact that projects from the first cell stack is tilted further away from the less flexible contact of the second cell stack prior to being connected to the less flexible contact of the second cell stack, wherein the more flexible contact that projects from the second cell stack is tilted further away from the less flexible contact of the first cell stack prior to being connected to the less flexible contact of the first cell stack.

11. The battery pack electrical connection system of claim 9, wherein at least one terminal of a battery cell of the first cell stack is connected directly to the more flexible contact that projects from the first cell stack, and at least one terminal of a battery cell of the first cell stack is connected directly to the less flexible contact that projects from the first cell stack.

12. A battery pack electrical connection method, comprising:
overlapping a first electrical contact that projects from a first cell stack with a second electrical contact that projects from a second cell stack;
connecting the first electrical contact and the second electrical contact; and
tilting the first electrical contact toward the second electrical contact during the connecting.

13. The battery pack electrical connection method of claim 12, further comprising connecting the first electrical contact to the second electrical contact with a mechanical fastener.

14. The battery pack electrical connection method of claim 12, wherein the tilting comprises tilting the first electrical contact vertically downward.

15. The battery pack electrical connection method of claim 12, wherein the first electrical contact is flexible relative to the second electrical contact.

16. The battery pack electrical connection method of claim 12, wherein the first electrical contact is a first busbar connected directly to a first terminal of a first battery cell, and the second electrical contact is a second busbar connected directly to a second terminal of a second battery cell.

17. The battery pack electrical connection method of claim 16, wherein the first battery cell is within the first cell stack, and the second battery cell is within a second cell stack.

18. The battery pack electrical connection method of claim 12, wherein the first electrical contact and the second electrical contact are more aligned after the connecting than before the connecting.

19. The battery pack electrical connection method of claim 12, further comprising moving the first cell stack and the second cell stack closer to each other to cause the overlapping.
